(19) United States
(12) Patent Application Publication
(10) Pub. No.: US 2011/0053285 A1
(43) Pub. Date: Mar. 3, 2011

(54) SENSOR USING MASS ENHANCEMENT OF NANOPARTICLES

(75) Inventors: Sang Min JEON, Pohang-si (KR); Hye Jung SEO, Chuncheon-si (KR); Soo Suk LEE, Suwon-si (KR)

(73) Assignees: SAMSUNG ELECTRONICS CO., LTD., Suwon-si (KR); POSTECH ACADEMY INDUSTRY FOUNDATION, Pohang-si (KR)

(21) Appl. No.: 12/869,420

(22) Filed: Aug. 26, 2010

(30) Foreign Application Priority Data
Aug. 27, 2009 (KR) 10-2009-0079952
Aug. 23, 2010 (KR) 10-2010-0081315

(51) Int. Cl. G01N 21/00

(52) U.S. Cl. 436/164; 422/69

(57) ABSTRACT

Provided herein is a method of detecting a biomolecule, which enhances a mass of the target biomolecule by irradiating light to a photocatalytic nanoparticle binding to the target biomolecule. Accordingly, the method can effectively detect a change in mass, and provide economical and rapid detection using a low-priced photocatalyst.

### CROSS-REFERENCE TO RELATED APPLICATION

This application claims priority to Korean Patent Application No. 10-2009-0079952, filed on Aug. 27, 2009 and Korean Patent Application No. 10-2010-0081315, filed on Aug. 23, 2010, and all the benefits accruing therefrom under 35 U.S.C. §119, the contents of which in their entirety are hereby incorporated by reference.

### BACKGROUND

1) Field

The disclosure relates to a sensor for detecting a biomolecule using mass enhancement, and more particularly, to a method of detecting a biomolecule to increase detection sensitivity by enhancing a mass of the biomolecule.

2) Description of the Related Art

To detect protein using a fluorescent marker has problems of a change in properties of protein, difficulty in attaching the fluorescent marker, and a high cost. To increase reaction area has a problem of a complicated process for forming nanostructures.

A mass enhancement method including binding antigens to which gold nanoparticles are attached to a quartz vibrator to which an antibody is bound and reduction-coating the vibrator with silver has been disclosed. Such a mass enhancement method for nanoparticles applies for binding nanoparticles after biomolecules reaction, and does not need complicated pretreatment because a signal can be amplified by silver enhancement. However, in this method, silver may be precipitated from a solution as well as the gold particles, caused by use of a catalyst, such as hydroquinone, for mass enhancement.

### SUMMARY

The general inventive concept includes a method of detecting binding of a nanoparticle to a target biomolecule by selectively enhancing a mass of the nanoparticle specifically binding to the target biomolecule.

In one aspect, a sensor for detecting a change in mass due to specific binding to a target biomolecule is provided. Here, mass enhancement is carried out by irradiating light to a photocatalytic nanoparticle specifically binding to the target biomolecule.

The photocatalytic nanoparticle may enhance the mass by absorbing light and coating metal ions on the surface of a photocatalyst.

The photocatalytic nanoparticle may be a catalytic particle for stimulating a physical and/or chemical reaction of a material present around the photocatalyst by absorbing light. Due to the reaction stimulated by the photocatalyst, the mass of the photocatalyst may be enhanced. In the embodiment, the photocatalytic nanoparticle may stimulate a reaction, for example, an oxidation-reduction reaction, in which a material dissolved in a periphery, for example, a solution, of the photocatalytic nanoparticles is precipitated by absorbing light having a specific wavelength, for example, a wavelength of a Ultraviolet or visible ray.

The photocatalytic nanoparticle may be a common photocatalytic particle such as titanium oxide or zinc oxide, or a particular catalytic particle such as a quantum dot. A size of the particle may be about 10 nm to about 100 nm.

The biomolecule includes an antigen, an antibody, DNA (deoxyribonucleic acid), and RNA (Ribonucleic acid).

The photocatalytic nanoparticle specifically binds to a target biomolecule. It may directly bind to the target biomolecule, or indirectly bind to a probe specifically binding to the target biomolecule. For example, the nanoparticle may be attached to an antibody capable of binding to an antigen binding to a surface of the sensor, thereby forming a direct bond using a specific binding reaction. In another example, a primary antibody is attached to the surface of the sensor, and the nanoparticle is attached to a secondary antibody specifically binding to an antigen, thereby forming an indirect bond.

The sensor may detect a change in mass, and may be any one of various sensors for detecting the mass change, for example, although not limited to, a quartz vibrator microbalance or cantilever sensor for detecting a change in vibration characteristic according to the mass change, a surface acoustic wave (SAW) sensor for detecting a change in frequency of a SAW according to the mass change, or a surface plasmon resonance (SPR) sensor for detecting a change in reflective index according to the mass change.

In another aspect, a sensor for detecting a biomolecule includes: a surface of the sensor on which binding of the biomolecule occurs and a change in mass is detected; a photocatalytic nanoparticle binding to the biomolecule on the surface of the sensor; a solution including a component enhancing a mass of the photocatalytic nanoparticle; and a device for irradiating light to the photocatalytic nanoparticle.

The device for irradiating light may irradiate a UV or visible ray, and the photocatalytic nanoparticle may be titanium oxide, zinc oxide, or a quantum dot.

In still another aspect, a method of enhancing a mass by irradiating light to a photocatalytic nanoparticle is provided.

While the photocatalytic nanoparticle is not theoretically limited, when light is irradiated to the photocatalytic nanoparticle, the photocatalytic nanoparticle is activated due to the incident light, and a material present around an activated photocatalyst is adsorbed to the photocatalyst through an oxidation-reduction reaction, thereby enhancing the mass of the photocatalyst.

A material capable of enhancing the mass of the photocatalytic nanoparticle may be metal ions capable of being eluted from a solution by an oxidation-reduction reaction. For example, the metal ions may be silver (Ag), copper (Cu), gold (Au), or palladium (Pd) ions.

The mass enhancement of the photocatalytic nanoparticles may be detected by changes in vibration characteristic, frequency, and reflective index. Accordingly, the mass enhancement may be detected using a quartz vibrator microbalance, a cantilever sensor, a SAW sensor, or an SPR sensor.

In another exemplary embodiment, the mass enhancement of the photocatalytic nanoparticles may be detected by the change in photoreaction characteristic such as absorbance or reflectivity.

In yet another aspect, a method of measuring mass enhancement of photocatalytic nanoparticles includes: irradiating light to a solution including a photocatalytic nanoparticle and a mass enhancing component; and measuring at least one change in characteristics of reflection, absorbance and scattering of the light to which the light is irradiated.

The method of detecting mass enhancement of photocatalytic nanoparticles may use a low-priced photocatalytic nanoparticle, and provide selective mass enhancement of a nanoparticle because a separate reducing agent is not used.

In addition, since the photocatalytic nanoparticle is subjected to the mass enhancement and the change in optical characteristics such as absorbance or reflectivity, the occurrence of mass enhancement and a degree thereof may be precisely measured by examining various photoreaction characteristics.

### BRIEF DESCRIPTION OF THE DRAWINGS

The above and other aspects of the general inventive concept will become more readily apparent by describing in further detail example embodiments thereof with reference to the accompanying drawings, in which:

FIG. 1 is a schematic view illustrating binding of photocatalytic nanoparticles and reduction of metal ions to increase sensitivity to a biomolecule;

FIG. 2 is a photograph illustrating the comparison of colors of mixtures of a titanium oxide photocatalytic nanoparticle solution with a silver nitrate solution before and after UV irradiation;

FIG. 3 is a graph illustrating the comparison of absorbance before and after a UV ray is irradiated to titanium oxide photocatalytic nanoparticles; and

FIG. 4 is a graph illustrating frequency changes caused by mass enhancement of photocatalytic nanoparticles.

### DETAILED DESCRIPTION

The general inventive concept now will be described more fully hereinafter with reference to the accompanying drawings, in which various example embodiments are shown. This invention may, however, be embodied in many different forms, and should not be construed as limited to the example embodiments set forth herein. Rather, these example embodiments are provided so that this disclosure will be thorough and complete, and will fully convey the scope of the general inventive concept to those of ordinary skill in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated regions, integers, steps, operations, elements, and/or components, but do not preclude the presence or addition of one or more other regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments are described herein with reference to cross section illustrations that are schematic illustrations of idealized embodiments. As such, variations from the shapes of the illustrations as a result, for example, of manufacturing techniques and/or tolerances, are to be expected. Thus, example embodiments described herein should not be construed as limited to the particular shapes of regions as illustrated herein but are to include deviations in shapes that result, for example, from manufacturing. For example, a region illustrated or described as flat may, typically, have rough and/or nonlinear portions. Moreover, sharp angles that are illustrated may be rounded. Thus, the regions illustrated in the figures are schematic in nature and their shapes are not intended to illustrate the precise shape of a region and are not intended to limit the scope of the present claims.

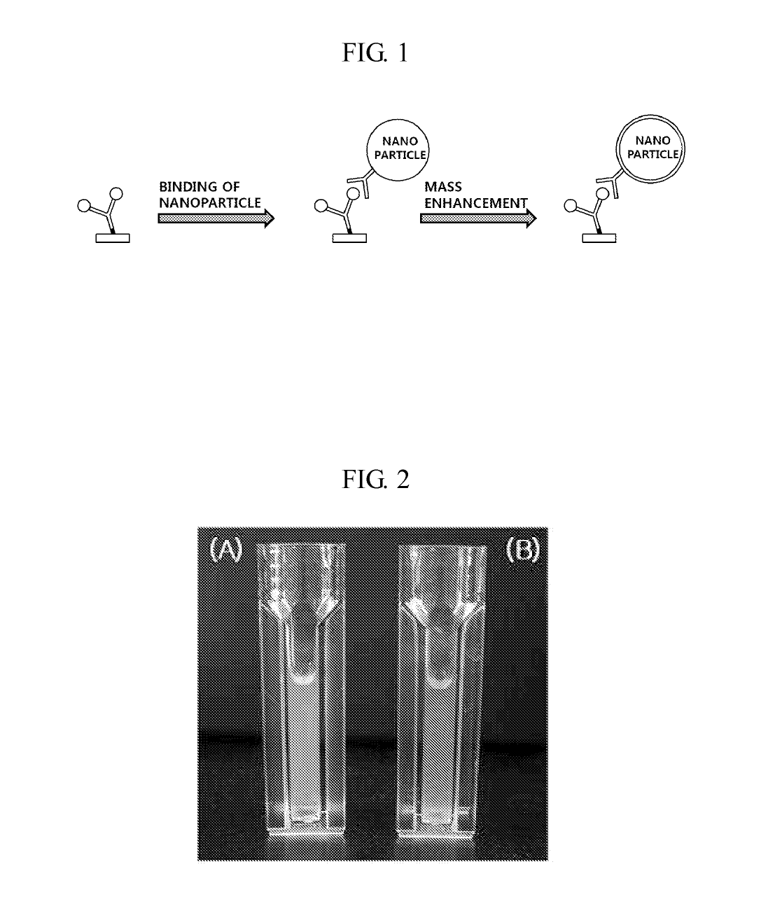

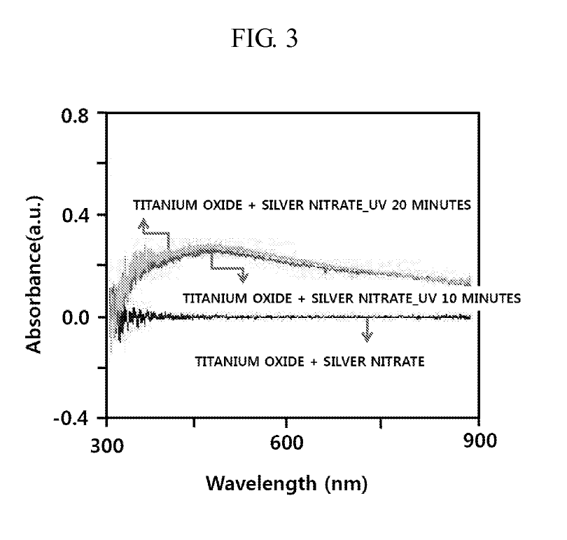

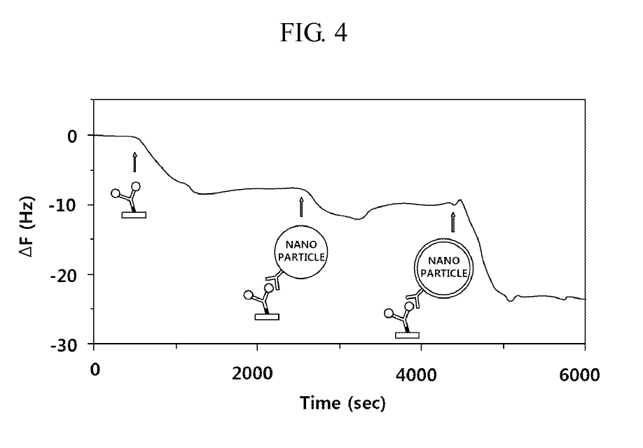

FIG. 1 is a schematic view illustrating binding of photocatalytic nanoparticles and reduction of metal ions to increase sensitivity to a biomolecule, FIG. 2 is a photograph illustrating the comparison of colors of mixtures of a titanium oxide photocatalytic nanoparticle solution with a silver nitrate solution before and after UV irradiation, FIG. 3 is a graph illustrating the comparison of absorbance before and after a UV ray is irradiated to titanium oxide photocatalytic nanoparticles, and FIG. 4 is a graph illustrating frequency changes caused by mass enhancement of photocatalytic nanoparticles.

First, as shown in FIGS. 2 and 3, light is irradiated to photocatalytic nanoparticles to examine mass enhancement. A titanium oxide nanoparticle solution is mixed with a silver nitrate solution, and a UV ray is irradiated thereto. FIG. 2(A) shows the mixture before the UV irradiation, which is opaque white or the color of titanium oxide. FIG. 2(B) shows the mixture after the UV irradiation, in which silver ions on a surface of the titanium oxide are reduced due to the UV irradiation, and whose color is changed to light brown. As time passes, the size of particle is increased, and floating matters in the solution sink.

Further, the change in absorbance is examined. FIG. 3 shows the comparison of absorbance before and after a UV ray is irradiated after a titanium oxide nanoparticle solution is mixed with a silver nitrate solution. The black line indicates an absorbance of titanium oxide before the UV irradiation. On the basis of this line, the change in absorbance according to UV irradiation time is relatively measured. The red line indicates an absorbance measured after UV is irradiated to a mixed solution of titanium oxide and silver nitrate for 10 minutes, and the green line indicates an absorbance measured after the UV irradiation for 20 minutes. When a UV ray is irradiated to the mixed solution of the titanium oxide and silver nitrate, silver ions in the solution are reduced, and thus formed on a surface of the titanium oxide. Accordingly, the size of the particle is increased, and the absorbance is also increased. It can be seen that, after the UV irradiation, the size of the titanium oxide particles enhanced by silver in the solution is gradually increased, and finally precipitated.

Afterwards, the reaction described above is applied to antigen detection. As shown in FIG. 1, first, antibodies are immobilized on a surface of a sensor, and photocatalytic nanoparticles having antigens capable of binding to antibodies are bound. Then, mass enhancement occurs, and thus it can more sensitively examine the binding of antigens.

Surface Treatment of Sensor

To detect antigens, antibodies are immobilized on a surface of the sensor. The immobilization of the antibodies is carried out by the following procedures. First, an oxide layer is formed on the surface of the sensor using a sol-gel method. Tetraethoxysilane (Sigma-Aldrich), water, ethanol (Sigma-Aldrich), and 1 M hydrochloric acid (Matsunoen Chemicals) are mixed in a ratio of 1:1:4:0.1 and sufficiently stirred for 3 hours. A thin film is formed on the surface of the sensor by spin coating (3000 rpm, 1 minute), plasticized at 400° C. for 1 hour, and then cooled to room temperature. A hydroxyl group (—OH) is formed on the surface of the sensor by irradiating a UV ray at 254 nm for 20 minutes. Subsequently, a single molecule layer is formed by soaking the sensor in a 0.1% 3-aminopropyltriethoxysilane (3-APTES; Sigma) solution, and activated with 2.5% glutaraldehyde (Sigma-Aldrich). To improve orientation of the antibodies, secondary antibodies [anti-mouse IgG (whole molecule) alkaline phosphatase conjugates; Sigma] are previously immobilized, and primary antibodies (anti-alpha fetoproteins; anti-AFP; HBI) are immobilized. Then, changes in oscillation frequency occurring before and after a reaction with antigens (alpha fetoproteins; AFP; HBI) is measured.

The surface treatment of the sensor is not limited to the specific method described above, and thus may be properly carried out by known methods depending on the sensor and the surface of the sensor.

In one example, a surface of a SAW sensor may be treated with a thin film of silicon dioxide, and a biomolecule probe may be immobilized by a known method.

In addition, an SPR sensor may use a single molecule layer of mercaptoundecanoic acid (MUA) to immobilize a biomolecule probe on a surface of an Au thin layer or a thiol (—SH)-binding biomolecule probe.

Surface Treatment of Photocatalytic Nanoparticles

To change a vibration characteristic by mass enhancement using photocatalytic nanoparticles, it is necessary to treat surfaces of photocatalytic nanoparticles. Mostly, the photocatalytic nanoparticles are metal oxides, and thus a single molecule layer is formed of 3-APTES and glutaraldehyde and antibodies specifically binding to antigens are immobilized on the surface of the sensor according to the same procedures as applied to the sensor surface.

Mass Enhancement using Photocatalytic Nanoparticles

The target biomolecule and the photocatalytic nanoparticle are sequentially reacted on the surface of the sensor, and soaked in a metal ion solution, and light suitable for a photocatalytic characteristic is irradiated, thereby reducing the metal ions into a metal on the surface of the photocatalytic nanoparticle.

In an example, antigens are reacted with the surface of the sensor, and the photocatalytic nanoparticles on which antibodies are immobilized are bound to the antigens in the form of a sandwich. Then, the resulting product is soaked in a silver nitrate solution (Aldrich), and light suitable for a photocatalytic characteristic is irradiated to reduce silver ions in the solution onto the surface of the photocatalyst.

FIG. 4 shows frequency changes measured from a quartz vibrator in respective steps. From a mass enhancement test for nanoparticles using a quartz vibrator microbalance, it can be seen that specific binding of biomolecules is created, which is detected by a decreased frequency of the quartz vibrator when antibodies capable of sensing alpha fetoprotein are immobilized on a surface of the quartz vibrator, and antigens are injected. To confirm the improvement in detection sensitivity, after the antibody-immobilized nanoparticles are injected, the mass of the nanoparticle is enhanced using a silver nitrate solution. The result shows that a higher frequency change is found when the mass enhancement occurs by the binding of the nanoparticles than when actual antibodies are detected. Consequently, when the mass of a target material is increased by mass enhancement of nanoparticles during the detection of the biomolecule, a biosensor having a higher sensitivity than the conventional sensor can be developed.

While exemplary embodiments have been disclosed herein, it should be understood that other variations may be possible. Such variations are not to be regarded as a departure from the spirit and scope of exemplary embodiments of the present application, and all such modifications as would be obvious to one skilled in the art are intended to be included within the scope of the following claims.

What is claimed is:

1. A method of detecting a biomolecule, comprising:
reacting a target biomolecule to a sensor for detecting a mass change caused by binding of the target biomolecule,
binding the target biomolecule to a photocatalytic nanoparticle, and
irradiating light to the photocatalytic nanoparticle for mass enhancement.

2. The method of claim 1, wherein the photocatalytic nanoparticle absorbs light and metal ions included in a solution are coated on a surface on the photocatalyst, thereby enhancing the mass.

3. The method of claim 2, wherein the photocatalytic nanoparticle stimulates oxidation-reduction of the metal ions.

4. The method of claim 1, wherein the light is a ultraviolet or visible ray.

5. The method of claim 1, wherein the photocatalytic nanoparticle includes titanium oxide, zinc oxide, a quantum dot, or a composite of at least two thereof.

6. The method of claim 2, wherein the metal ions include at least one selected from silver, copper, gold, and palladium ions.

7. The method of claim 1, wherein the sensor includes one selected from a quartz vibrator microbalance, a cantilever sensor, a surface acoustic wave (SAW) sensor, and a surface plasmon resonance (SPR) sensor.

8. A sensor for detecting specific bindings of biomolecules, comprising:
a sensor binding to a biomolecule and configured to detect a change in mass;
a photocatalytic nanoparticle binding to the biomolecule on a surface of the sensor;
a solution including a component enhancing a mass of the photocatalytic nanoparticle; and
a device configured to irradiate light to the photocatalytic nanoparticle.

9. The sensor of claim 8, wherein the device configured to irradiate light irradiates a ultraviolet or visible ray.

10. The sensor of claim 8, wherein the photocatalytic nanoparticle includes titanium oxide, zinc oxide, or a quantum dot.

11. The sensor of claim 8, wherein the mass enhancing component includes at least one selected from silver, copper, gold, and palladium ions.

12. The sensor of claim 8, which is selected from a quartz vibrator microbalance, a cantilever sensor, a surface acoustic wave (SAW) sensor, and a surface plasmon resonance (SPR) sensor.

13. A method of enhancing a mass of a nanoparticle by irradiating light to a solution including a photocatalytic nanoparticle and a mass enhancing component.

14. The method of claim 13, wherein the mass enhancing component is metal ions.

15. The method of claim 14, wherein the photocatalyst stimulates an oxidation-reduction reaction of the metal ions.

16. The method of claim 15, wherein the metal ions include at least one selected from silver, copper, gold, and palladium ions.

17. The method of claim 13, wherein the photocatalytic nanoparticle is formed of titanium oxide, zinc oxide, or a quantum dot.

18. The method of claim 13, wherein the light is a ultraviolet or visible ray.

19. The method of claim 13, wherein the photocatalytic nanoparticle has an average diameter of about 10 nm to about 100 nm.

20. A method of measuring mass enhancement, comprising:
irradiating light to a solution including a photocatalytic nanoparticle and a mass enhancing component; and
measuring at least one change in characteristics of reflection, absorbance and scattering of the solution to which the light is irradiated.
